(19) United States
(12) Patent Application Publication
(10) Pub. No.: US 2016/0307202 A1
(43) Pub. Date: Oct. 20, 2016

(54) OPTIMAL SALES OPPORTUNITY VISUALIZATION

(71) Applicant: SugarCRM Inc., Cupertino, CA (US)

(72) Inventors: Charles Godewyn, Phoenix, AZ (US); Ing-Marie Jonsson, Los Gatos, CA (US); Kathrin Kohlhaufl, San Jose, CA (US); Riley McLoed, Sunnyvale, CA (US); Maria Zolotova, Mountain View, CA (US)

(21) Appl. No.: 14/686,765

(22) Filed: Apr. 14, 2015

(51) Int. Cl. G06Q 30/00; G06Q 10/06

(52) U.S. Cl. CPC G06Q 30/01; G06Q 10/06316

(57) ABSTRACT

Embodiments of the invention provide a method, system and computer program product for optimal sales opportunity visualization in a CRM application. The method includes storing different data for different business opportunities previously closed and won. The method also includes loading from the data store business opportunity data for a potential sale. The method further includes generating a visualization for an aggregation of the different data representative of an optimal sales opportunity and also generating a visualization from the business opportunity data for the potential sale. Finally, the method includes displaying a comparison of the visualizations and providing an alert responsive to a determination that the visualization from the business opportunity data for the potential sale varies by a threshold amount from the visualization for the aggregation of the different data representative of the optimal sales opportunity.

### BACKGROUND OF THE INVENTION

1. Field of the Invention

The present invention relates to customer relationship management (CRM) and more particularly to opportunity management in a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. All sales opportunities arranged along each of the sales steps that make up the sales process represented by the sales pipeline. Thus, a business opportunity is a qualified and validated lead for a potential sale of a product or service.

Business opportunity management usually is a task reserved for each individual sales person. Consequently, the proper management of a business opportunity can rise or fall with the skill and experience of a managing sales person. Sales persons of particular experience can drive a business opportunity to closed and won sale. Conversely, a sales person of little experience can drive the same business opportunity to a closed and lost sale. Therefore, providing expert guidance to a sales force can help to ensure that all business opportunities are most likely to result in closed and won sales.

### BRIEF SUMMARY OF THE INVENTION

Embodiments of the present invention address deficiencies of the art in respect to business opportunity management and provide a novel and non-obvious method, system and computer program product for optimal sales opportunity visualization in a CRM application. In an embodiment of the invention, a method for optimal sales opportunity visualization in a CRM application includes storing in a data store of the CRM application different data for different business opportunities previously closed and won. The method also includes loading from the data store business opportunity data for a potential sale in the CRM application in association with a sales representative end user of the CRM application. The method further includes generating a visualization for an aggregation of the different data as being representative of an optimal sales opportunity and also generating a visualization from the business opportunity data for the potential sale. Finally, the method includes displaying a comparison of the visualizations in a user interface to the CRM application and providing in the user interface an alert responsive to a determination that the visualization from the business opportunity data for the potential sale varies by a threshold amount from the visualization for the aggregation of the different data representative of the optimal sales opportunity.

In one aspect of the embodiment, the data for the different business opportunities previously closed and won includes a correlation between timing information pertaining to a transitioning of each of the business opportunities previously closed and won from one stage of a sales cycle to another. Optionally, the data for the different business opportunities previously closed and won also includes a correlation between timing information pertaining to an occurrence of different actions in the CRM application, such as a meeting, a telephone call and a task, and the timing information pertaining to the transitioning of each of the business opportunities previously closed and won from one stage of the sales cycle to another. Consequently, the alert can include a list of one or more of the different actions correlated with a transitioning of the different business opportunities previously closed and won from a stage of the sales cycle contemporaneously associated with business opportunity data for the potential sale and a next stage of the sales cycle.

Finally, in yet another aspect of the embodiment, the method additionally can include specifying in connection the business opportunity data for the potential sale, a hypothetical action in association with a sales representative end user of the CRM application. Thereafter, the visualization from the business opportunity data for the potential sale is re-generated as if the hypothetical action had been contemporaneously performed. Further, a comparison of the visualizations in the user interface to the CRM application is re-displayed so as to account for the re-generated visualization.

In another embodiment of the invention, a method for optimal sales opportunity visualization in a CRM application includes storing in a data store of the CRM application different data for different business opportunities previously closed and lost. The method also includes loading from the data store business opportunity data for a potential sale in the CRM application in association with a sales representative end user of the CRM application. The method further includes generating a visualization for an aggregation of the different data representative of the business opportunities previously closed and lost as indicative of an errant sales opportunity, and also generating a visualization from the business opportunity data for the potential sale. Finally, the method includes displaying a comparison of the visualizations in a user interface to the CRM application and providing in the user interface an alert responsive to a determination that the visualization from the business opportunity data for the potential sale is similar by a threshold amount to the visualization of the errant sales opportunity.

In yet another embodiment of the invention, a CRM data processing system is configured for optimal sales opportunity visualization. The system includes a host computing system that includes at least one computer with memory and at least one processor. The system also includes a CRM application executing in the memory of the host computing system. The system yet further includes a data store of the CRM application storing different data for different business opportunities previously closed and won as well as business opportunity data for different potential sales in the CRM application in association with different sales representative end users of the CRM application. Finally, the system includes an optimal sales opportunity visualization module coupled to the CRM application.

The module includes program code enabled upon execution in the memory of the host computing system to load from the data store business opportunity data for a potential sale in the CRM application in association with a sales representative end user of the CRM application. The program code also is enabled to generate a visualization for an aggregation of the different data representative of an optimal sales opportunity and also generating a visualization from the business opportunity data for the potential sale. The program code yet further is enabled to display a comparison of the visualizations in a user interface to the CRM application. Finally, the program code is enabled to provide in the user interface an alert responsive to a determination that the visualization from the business opportunity data for the potential sale varies by a threshold amount from the visualization for the aggregation of the different data representative of the optimal sales opportunity.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for optimal sales opportunity visualization in a CRM application;

FIG. 2 is a schematic illustration of a CRM data processing system configured for optimal sales opportunity visualization; and,

FIG. 3 is a flow chart illustrating a process for optimal sales opportunity visualization in a CRM application.

### DETAILED DESCRIPTION OF THE INVENTION

Embodiments of the invention provide for optimal sales opportunity visualization in a CRM application. In accordance with an embodiment of the invention, activities occurring in a CRM application are recorded in respect to different business opportunities resulting in either closed and won sales or closed and lost sales. Further, dates on which each of the different business opportunities transition from one stage of the sales cycle to another are recorded. Thereafter, one or more visualizations can be generated based upon the recorded activities and the transition of the different business opportunities. In this regard, the visualizations can include a visualization directed to a comparison of an average number of days elapsed for each stage of the sales cycle for successfully closed and won business opportunities, as well as a visualization directed to a comparison of an average number of days elapsed for each stage of the sales cycle for unsuccessfully closed and lost business opportunities.

Thereafter, data in the CRM application pertaining to a contemporaneous business opportunity managed by a particular end user of the CRM application can be monitored including a number of days elapsed since an inception of the contemporaneous business opportunity and any activities performed or merely scheduled in connection with the contemporaneous business opportunity. A visualization likewise can be generated directed to a comparison of the number of days elapsed and any sales cycle transitions having already occurred for the contemporaneous business opportunity. The visualization generated for the contemporaneous business opportunity can be displayed in a user interface of the CRM application along with both a similar visualization generated for the successfully closed and won business opportunities and also a similar visualization generated for the unsuccessfully closed and lost business opportunities.

To the extent that the visualization for the contemporaneous business opportunity compares unfavorably to that of the successfully closed and won business opportunities, an alert can be presented in the user interface noting the undesirable variance in both visualizations. Conversely, to the extent that the visualization for the contemporaneous business opportunity compares favorable to that of the unsuccessfully closed and lost business opportunities, an alert can be presented in the user interface noting the undesirable similarity in both visualizations. Optionally, the alert can include a recommendation to perform one or more actions in the CRM application previously correlated with a transition of one or more successfully closed and won business opportunities to a next stage of the sales cycle.

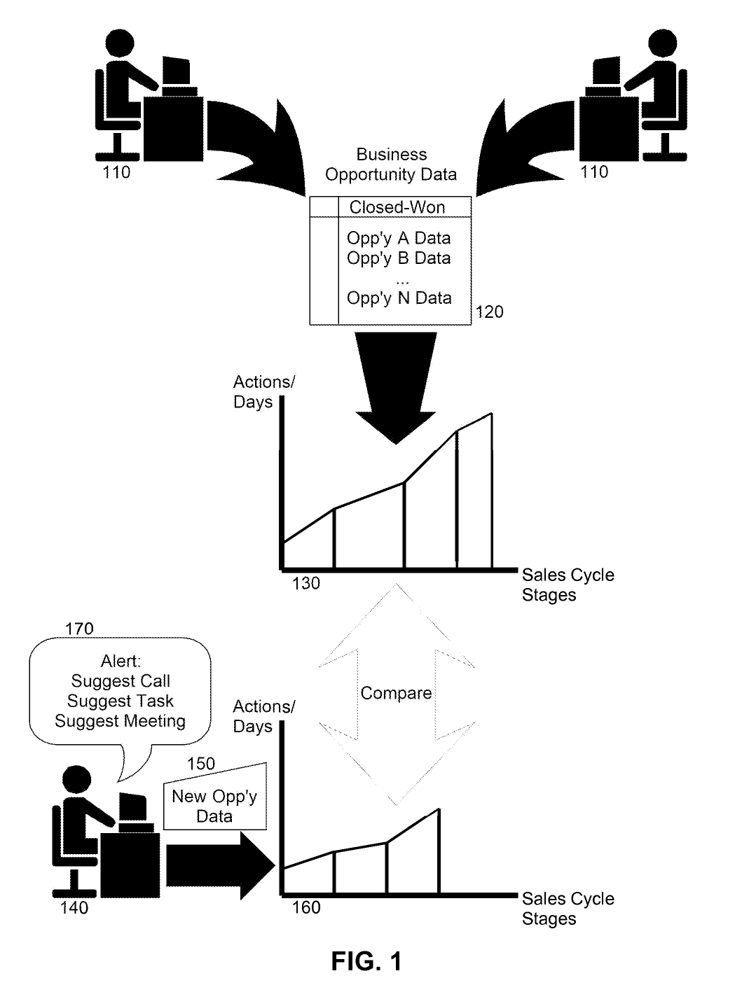

In further illustration, FIG. 1 pictorially shows a process for optimal sales opportunity visualization in a CRM application. As shown in FIG. 1, different end users 110 of a CRM application can manage individual business opportunities for which data 120 can be collected for those of the business opportunities resulting in successfully closed and won sales. The data 120 can include a timing of each transition of the sales cycle for each of the business opportunities from inception to prospecting to first appointment to qualifying to pitching to overcoming sales objections to closing. The data 120 further can include different actions taken in respect to each business opportunity and a timing of each action so as to produce a correlation between the different actions and the different transitions.

Of note, the data 120 is used to generate one or more visualizations 130. Each of the visualizations 130 can compare the stages of the sales cycle for all of the business opportunities and either the actions performed in connection with the transitions of the sales cycle, or the duration of time between each of the transitions. The visualizations can reflect an averaging of the data 120 for all of the business opportunities, or for selected groupings of the business opportunities, for example groupings created in accordance with different characteristics of the business opportunities such as the geographic location of each of the business opportunities, an amount at stake for each of the business opportunities, or a company size of each of the business opportunities.

Thereafter, data 150 for a contemporaneous business opportunity managed by a particular end user 140 can be collected. A visualization 160 for the contemporaneous business opportunity is generated and compared to one or more of the previously generated visualizations 130. To the extent that a threshold variance is detected as between the visualization 130 and the visualization 160, an alert 170 can be provided to the particular end user 140 in the CRM application. The alert 170 can include one or more suggested actions previously correlated with an advancement of the sales cycle from the data 120. In this way, the particular end user 140 can enjoy the benefit of business opportunity management experience of the other end users 110 in managing the contemporaneous business opportunity.

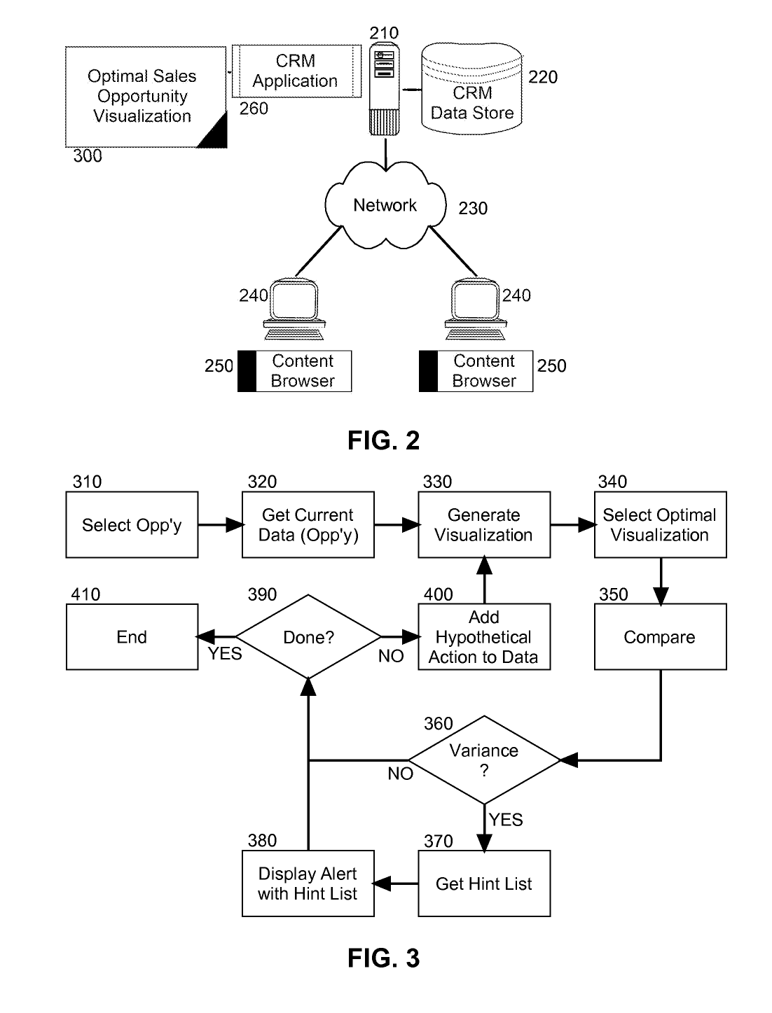

The process described in connection with FIG. 1 can be implemented in a CRM data processing system. In yet further illustration, FIG. 2 schematically illustrates a CRM data processing system configured for optimal sales opportunity visualization. The system includes a host computing system 210 that includes one or more computers, each with memory and at least one processor. A CRM application 260 executes in the host computing system 210. The CRM application 260 provides access to CRM data in a CRM data store 220 to different end users through content browsers 250 of respectively different computers 240 over computer communications network 230. Importantly, an optimal sales opportunity visualization module 300 is coupled to the CRM application 260.

The optimal sales opportunity visualization module 300 includes program code enabled upon execution in the memory of the host computing system 210 to generate one or more visualizations of data collected with respect to prior business opportunities in the CRM application 260 previously successfully closed as won sales. The program code is further enabled to collect data for a contemporaneous business opportunity and to generate from the collected data a visualization of the collected data. The program code yet further is enabled to compare the generated visualization with at least one of the visualizations generated for the prior business opportunities. To the extent a threshold variance is detected, the program code is enabled to display an alert and to include in the alert, one or more suggested actions previously correlated with an advancement of a sales cycle of the prior business opportunities.

In even yet further illustration of the operation of the optimal sales opportunity visualization module 300, FIG. 3 is a flow chart illustrating a process for optimal sales opportunity visualization in a CRM application. Beginning in block 310, a contemporaneous business opportunity is selected in the CRM application and in block 320, data for the contemporaneous business opportunity is loaded into memory. Thereafter, in block 330, a visualization is generated for the data and, in block 340, a previously generated visualization for prior business opportunities is selected. In block 350, the visualizations are compared and in decision block 360, it is determine if a threshold variance exists.

In decision block 360, if a threshold variance is determined to exist as between the visualizations, in block 370 a hint list is assembled. The hint list includes one or more actions previously correlated with a successful advancement of the prior business opportunities from one stage of the sales cycle to a next stage of the sales cycle. Thereafter, in block 380, an alert is displayed along with the hint list. Subsequently, in decision block 390 it is determined if no further processing is requested. If so, in block 410 the process can end.

Otherwise, in block 400 a hypothetical action can be selected for inclusion in the data for the contemporaneous opportunity. Thereafter, the visualization is re-generated in block 330 for the data of the contemporaneous business opportunity including the hypothetical action and, with the selection of an optimal visualization in block 340, compared once again in block 350 to the selected optimal visualization so as to detect any variance in decision block 360. In this way, what-if scenarios can be visualized for a contemporaneous business opportunity leveraging the knowledge of the prior business opportunities known to have successfully closed with won sales.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for optimal sales opportunity visualization in a customer relationship management (CRM) application, comprising:
storing in a data store of the CRM application different data for different business opportunities previously closed and won;
loading from the data store business opportunity data for a potential sale in the CRM application in association with a sales representative end user of the CRM application;
generating a visualization for an aggregation of the different data representative of an optimal sales opportunity and also generating a visualization from the business opportunity data for the potential sale;
displaying a comparison of the visualizations in a user interface to the CRM application; and,
providing in the user interface an alert responsive to a determination that the visualization from the business opportunity data for the potential sale varies by a threshold amount from the visualization for the aggregation of the different data representative of the optimal sales opportunity.

2. The method of claim 1, wherein the data for the different business opportunities previously closed and won includes a correlation between timing information pertaining to a transitioning of each of the business opportunities previously closed and won from one stage of a sales cycle to another.

3. The method of claim 2, wherein the data for the different business opportunities previously closed and won also includes a correlation between timing information pertaining to an occurrence of different actions in the CRM application and the timing information pertaining to the transitioning of each of the business opportunities previously closed and won from one stage of the sales cycle to another.

4. The method of claim 3, wherein the alert includes a list of one or more of the different actions correlated with a transitioning of the different business opportunities previously closed and won from a stage of the sales cycle contemporaneously associated with business opportunity data for the potential sale and a next stage of the sales cycle.

5. The method of claim 1, wherein the different actions include a meeting, a telephone call and a task.

6. The method of claim 1, further comprising:
specifying in connection the business opportunity data for the potential sale, a hypothetical action in association with a sales representative end user of the CRM application;
re-generating the visualization from the business opportunity data for the potential sale as if the hypothetical action had been contemporaneously performed; and,
re-displaying a comparison of the visualizations in the user interface to the CRM application.

7. A customer relationship management (CRM) data processing system configured for optimal sales opportunity visualization, the system comprising:
a host computing system comprising at least one computer with memory and at least one processor;
a CRM application executing in the memory of the host computing system;
a data store of the CRM application storing different data for different business opportunities previously closed and won as well as business opportunity data for different potential sales in the CRM application in association with different sales representative end users of the CRM application; and,
an optimal sales opportunity visualization module coupled to the CRM application, the module comprising program code enabled upon execution in the memory of the host computing system to load from the data store business opportunity data for a potential sale in the CRM application in association with a sales representative end user of the CRM application, to generate a visualization for an aggregation of the different data representative of an optimal sales opportunity and also generating a visualization from the business opportunity data for the potential sale, to display a comparison of the visualizations in a user interface to the CRM application, and to provide in the user interface an alert responsive to a determination that the visualization from the business opportunity data for the potential sale varies by a threshold amount from the visualization for the aggregation of the different data representative of the optimal sales opportunity.

8. The system of claim 7, wherein the data for the different business opportunities previously closed and won includes a correlation between timing information pertaining to a transitioning of each of the business opportunities previously closed and won from one stage of a sales cycle to another.

9. The system of claim 8, wherein the data for the different business opportunities previously closed and won also includes a correlation between timing information pertaining to an occurrence of different actions in the CRM application and the timing information pertaining to the transitioning of each of the business opportunities previously closed and won from one stage of the sales cycle to another.

10. The system of claim 9, wherein the alert includes a list of one or more of the different actions correlated with a transitioning of the different business opportunities previously closed and won from a stage of the sales cycle contemporaneously associated with business opportunity data for the potential sale and a next stage of the sales cycle.

11. The system of claim 7, wherein the different actions include a meeting, a telephone call and a task.

12. The system of claim 7, wherein the program code is further enabled to specify in connection the business opportunity data for the potential sale, a hypothetical action in association with a sales representative end user of the CRM application, to re-generate the visualization from the business opportunity data for the potential sale as if the hypothetical action had been contemporaneously performed, and to re-display a comparison of the visualizations in the user interface to the CRM application.

13. A computer program product for optimal sales opportunity visualization in a customer relationship management (CRM) application, the computer program product comprising a computer readable storage medium having program instructions embodied therewith, the program instructions executable by a device to cause the device to perform a method comprising:
storing in a data store of the CRM application different data for different business opportunities previously closed and won;
loading from the data store business opportunity data for a potential sale in the CRM application in association with a sales representative end user of the CRM application;
generating a visualization for an aggregation of the different data representative of an optimal sales opportunity and also generating a visualization from the business opportunity data for the potential sale;
displaying a comparison of the visualizations in a user interface to the CRM application; and,
providing in the user interface an alert responsive to a determination that the visualization from the business opportunity data for the potential sale varies by a threshold amount from the visualization for the aggregation of the different data representative of the optimal sales opportunity.

14. The computer program product of claim 13, wherein the data for the different business opportunities previously closed and won includes a correlation between timing information pertaining to a transitioning of each of the business opportunities previously closed and won from one stage of a sales cycle to another.

15. The computer program product of claim 14, wherein the data for the different business opportunities previously closed and won also includes a correlation between timing information pertaining to an occurrence of different actions in the CRM application and the timing information pertaining to the transitioning of each of the business opportunities previously closed and won from one stage of the sales cycle to another.

16. The computer program product of claim 15, wherein the alert includes a list of one or more of the different actions correlated with a transitioning of the different business opportunities previously closed and won from a stage of the sales cycle contemporaneously associated with business opportunity data for the potential sale and a next stage of the sales cycle.

17. The computer program product of claim 13, wherein the different actions include a meeting, a telephone call and a task.

18. The computer program product of claim 13, wherein the method further comprises:
specifying in connection the business opportunity data for the potential sale, a hypothetical action in association with a sales representative end user of the CRM application;
re-generating the visualization from the business opportunity data for the potential sale as if the hypothetical action had been contemporaneously performed; and,
re-displaying a comparison of the visualizations in the user interface to the CRM application.
